(19) United States
(12) Patent Application Publication
(10) Pub. No.: US 2025/0191357 A1
(43) Pub. Date: Jun. 12, 2025

(54) SYSTEM AND METHOD FOR AUTOMATICALLY CURATING AND DISPLAYING IMAGES

(71) Applicants: Sudheer Kumar Pamuru, Frisco, TX (US); Madhukiran Dandamudi, Frisco, TX (US); Vineel Kurma, Frisco, TX (US)

(72) Inventors: Sudheer Kumar Pamuru, Frisco, TX (US); Madhukiran Dandamudi, Frisco, TX (US); Vineel Kurma, Frisco, TX (US)

(21) Appl. No.: 19/056,178

(22) Filed: Feb. 18, 2025

Related U.S. Application Data
(63) Continuation-in-part of application No. 18/132,669, filed on Apr. 10, 2023, now Pat. No. 12,229,462.
(63) Continuation-in-part of application No. 17/683,032, filed on Feb. 28, 2022, now Pat. No. 11,861,665.

(51) Int. Cl. G06V 10/98; G06V 10/25; G06V 10/75; G06V 10/77

(52) U.S. Cl. CPC G06V 10/993; G06V 10/25; G06V 10/751; G06V 10/7715; G06V 10/987; G06V 2201/08

(57) ABSTRACT

The present disclosure is directed to automatically curating a set of images according to a predetermined set of compliance rules and displaying those images. The machine learning and artificial intelligence technology can differentiate between images and identify quality control features within images. The features may include excessive glare in the image; poor image resolution; dirt on the vehicle surface in the image; trash in the image; flags in the image; signs in the image; people or animals in the image, paper floor mats in the vehicle, etc. The technology is trained to identify these features in the images and automatically generate a quality control score based on these features. The system tags the images with information relating to the quality control score and may use this tag to automatically modify the image to raise the quality control score to the point where the image can be published.

### REFERENCE TO RELATED APPLICATIONS

This application is a continuation-in-part of prior pending U.S. patent application Ser. No. 18/132,669, filed on Apr. 10, 2023, to issue as U.S. Pat. No. 12,229,462 on Feb. 18, 2025, which is a continuation-in-part of U.S. patent application Ser. No. 17/683,032 filed Feb. 28, 2022, now U.S. Pat. No. 11,861,665 issued Jan. 2, 2024.

### TECHNICAL FIELD

The following disclosure relates generally to a machine learning artificial intelligence system for identifying and tagging features in an image, applying a set of rules to the tags, and automatically displaying a portion of the image according to the rules and, more particularly, automatically applying a set of compliance rules to a plurality of images and automatically displaying the images in conformance with the compliance rules.

### BACKGROUND

The present invention relates to an improvement on the systems and methods described

in U.S. patent application Ser. No. 18/132,669, filed on Apr. 10, 2023, to issue as U.S. Pat. No. 12,229,462 on Feb. 18, 2025 to Pamuru, Dandamudi, and Kurma, and to U.S. Pat. No. 11,488,371 to Pamuru and U.S. patent application Ser. No. 17/683,032 filed Feb. 28, 2022 that are all incorporated herein by this reference. When selling unique products, such as vehicles, online sellers often use images to allow potential purchasers to view the product. To streamline the online shopping experience, sellers often desire the images to be uniform to assist potential purchasers in comparing products to one another. Different sellers may have different guidelines for how they desire images to be presented, but for a particular seller, it is often desirable to have all images on a webpage comport to a preselected set of guidelines for displaying such images. Sellers can use their own cameras to capture videos or multiple images of an object for online display. While this solution avoids the necessity of costly professional equipment, the manual processes of using image manipulation tools to eliminate unwanted elements in the resulting images, to comport with the seller's desired presentation guidelines, can be time-consuming, expensive, and result in suboptimal uniformity in the final display of the images. Unfortunately, many of the images sellers have of their products are not uniform. This lack of uniformity may be attributable to inconsistent backgrounds, low detail, blurriness, poor perspective, shadows, glare, reflections, unwanted information, such as a license plate number, etc. Modifying these images to comport with the user's desired image presentation guidelines often requires complex software, and time-consuming and expensive human expertise in the field of digital image manipulation.

Users such as product sellers can use various types of software on devices, such as mobile phones, to modify the images of their products to comport with a desired set of presentation guidelines. One drawback associated with using this software to comport images to desired image display protocols is that modifying large numbers of images, images with multiple compliance issues, and images of sellers with multiple presentation guidelines can be costly and time-consuming and may result in less than optimal and/or inconsistent final image quality. It would be desirable to automate the process for modifying and displaying uniform images comporting with a pre-determined set of presentation guidelines.

While sellers can manually manipulate images to remove unwanted additional inventory, poles, trees, etc. in the background of an image, it would be desirable to automate the process and to add and remove additional presentation guidelines for different products and different target audiences. For images that lack focus or resolution, there exist in the art systems that sellers may use to sharpen and/or upscale images, but such systems require at least some knowledge and expertise on the part of the seller to implement such systems. Even with such knowledge and expertise, identifying, sharpening, and upscaling a large number of images is time-consuming. It would therefore be desirable to provide a system that allows a seller to automatically identify guidelines for images which a system automatically applies to a group of images to automatically sharpen and/or upscale as desired by the seller. It would also be desirable to allow a seller to select guidelines for images that a system automatically applies to a group of images to automatically identify and remove noise and undesirable artifacts such as fingerprints or smudges on the product, glare, reflections, etc.

Certain sellers may desire a group of displayed product images all show the same perspective of the product offerings. While initially capturing all of the images from the desired perspective addresses this issue, sometimes a seller receives videos, or images from multiple sources that may include multiple images taken from a plurality of perspectives. It would therefore be desirable to provide a system that allows a seller to automatically select guidelines for images that the system automatically applies to a group of images to automatically sort into images showing product from a predetermined perspective.

While systems exist to remove undesirable elements from images, such as rain, snow, fumes, smoke, and/or mud and noise in the background like trees, humans, or more cars, training these systems for particular products and elements selected by the seller, such systems often require the seller to have a knowledge and expertise associated with removing these undesirable elements from images. It would be desirable to provide a system that allows a seller to automatically identify guidelines for the display of images that the system automatically applies to a group of images to remove undesired elements selected by the seller.

Sellers use banners and overlays provided on images to provide potential buyers with information about the product displayed in the image. Sometimes images contain improperly cropped overlays or banners that a seller desires to modify or remove. It would be desirable to provide a system that allows a seller to automatically identify guidelines for images that the system automatically applies to a group of images to modify or remove overlays and/or banners as selected by the seller.

The present invention uses a machine learning artificial intelligence system to automatically tag all of the foregoing features in a group of images and allows a seller to select which of the tagged features the seller wishes the system to modify and in what manner to display the images in compliance with the seller's selected guidelines. This increases uniformity, saves time, and improves the quality of the displayed images to enhance the overall potential customer experience.

### SUMMARY OF THE DISCLOSED SUBJECT MATTER

The system and method of the present disclosure is directed to automatically curating and modifying a set of images according to a predetermined set of rules and displaying those images. The machine learning and artificial intelligence technology associated with the system and method can differentiate between images and identify features within images. Such features may include a desired perspective, inconsistent backgrounds, low detail, blurriness, shadows, glare, reflections, unwanted information, unwanted elements, poles, trees, lack or focus, poor resolution, rain, snow, fumes, smoke, mud, unwanted banners, unwanted overlays, etc.

The technology is trained to identify these features in the images and automatically tag the images with information relating to the features. A user selects a predetermined set of rules associated with image quality-control display criteria to be applied to the images. By way of example, the user may select a rule that the resulting displayed images should all have a blue background and show an object in the images from a side perspective. If the displayed image contains a vehicle, the user may select a rule that the resulting displayed images should not have extraneous items, such as signage, in the image, not have poor resolution, etc. The technology uses machine learning to identify the degree to which the image complies with the rules and assigns a quality control score to the image. The technology automatically highlights the quality control features in the image and displays them to the user. Depending on the quality control score, the technology may automatically publish the image to a website, correct the image to bring it into compliance with the rules, or prompt the user to determine if the image is acceptable. As an example, the technology may automatically identify those images showing unwanted signage in the image, and remove the signage from the image. At least one aspect of the present disclosure is directed to using technology to use aggregate input from users to train the machine learning model.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in, and constitute a part of, this specification.

### BRIEF DESCRIPTION OF DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a conceptual diagram illustrating an example system for generating a display of images in accordance with predetermined compliance rules, in accordance with one or more aspects of the present disclosure.

FIG. 2 is a perspective view of a user capturing object images and/or videos, in accordance with one or more aspects of the present disclosure.

FIG. 3 is a conceptual diagram illustrating an example graphical user interface presented by an example computing device that is configured to capture object images and/or videos at a physical location, in accordance with one or more aspects of the present disclosure.

FIG. 4 is a flowchart illustrating example operations performed by an example computing system that is configured to convert captured images or and/videos into a display of images in accordance with predetermined compliance rules, in accordance with one or more aspects of the present disclosure.

FIGS. 5A-5C is a flowchart illustrating example operations performed by an example computing device that is configured to tag images with features in the images and use the tags to implement rules modifying the images for display, in accordance with one or more aspects of the present disclosure

FIG. 6 is a list of features to be identified by machine learning and artificial intelligence in captured images of an object, in accordance with one or more aspects of the present disclosure.

FIG. 7 is a feature chart identifying features identified in captured images by machine learning and artificial intelligence, in accordance with one or more aspects of the present disclosure.

FIG. 8 is a set of images representing various features automatically identified and tagged by machine learning and artificial intelligence, in accordance with one or more aspects of the present disclosure.

FIG. 9 is a list of compliance rules for implementation in accordance with one or more aspects of the present disclosure.

FIG. 10 is a captured and unaltered image of a vehicle showing glare on a window, in accordance with one or more aspects of the present disclosure.

FIG. 11 is the captured image of FIG. 10, shown with the image automatically modified to remove the glare from the window, in accordance with one or more aspects of the present disclosure.

FIG. 12 is the captured image of FIG. 11, shown with the background removed by machine learning and artificial intelligence, in accordance with one or more aspects of the present disclosure.

FIG. 13 is the captured image of FIG. 12, shown with the background replaced by machine learning and artificial intelligence with a colored background, in accordance with one or more aspects of the present disclosure.

FIG. 14 is a display of webpage showing modified images sequenced and arranged, in accordance with one or more aspects of the present disclosure.

### DESCRIPTION OF EMBODIMENTS

In general, techniques of this disclosure may enable a computing device to access multiple images of different objects. A computing system associated with the computing device may analyze contextual information associated with the images and identify predetermined features in the images. The system digitally “tags” the images with information associated with the identified features by associating a piece of software code with the image. The system compares these tags to a predetermined list of rules governing how to address various features in the images. The system uses the tags to apply the appropriate rules to the images, based on the features identified in the images, to create modified images that the system displays.

For example, an automobile dealer may receive a plurality of images of vehicles for sale. The images may include images of the vehicles taken from various perspectives, with different backgrounds, and identifiable license plate numbers. The dealer, on its own, or to comport with third-party compliance rules, such as a vehicle manufacturer, may wish to display only those images of vehicles taken from a front perspective view, replace the existing backgrounds with a blue background, and blur the characters on the license plate. Compliance rules may require that the resulting displayed images should not have: excessive glare in the image; poor image resolution; dirt on the vehicle surface in the image; trash in the image; flags in the image; signs in the image; people or animals in the image, paper floor mats in the vehicle, etc. Different sets of compliance rules may be used for different vehicle manufacturers, different dealers, different markets, etc. The compliance rules are associated with a quality control score based on the extent to which the image does, or does not comply with the compliance rules. The dealer, or a third-party, may upload the images over the internet to a computer having a software system installed that examines the images for a predetermined list of features. The system receives the images, automatically uses a machine learning model to compare the images to the compliance rules to give each image a compliance score, automatically highlights in the image those quality control feature that are not in compliance with the compliance rules associates with that image. The system may tag the images with the identified quality control features and use those tags to highlight the images. The system may send the highlighted images to the user for review. If the compliance score is above a predetermined score, the system may publish the image directly to a predetermined website, such as the dealer's website or another desired location. If the compliance score is below a predetermined score, the system may request correction or feedback from the user. The system aggregates the user feedback and uses it to train the machine learning model. If desired, the dealer may apply this same process to manipulate and display videos, rather than images.

Techniques of this disclosure use machine learning artificial intelligence, such as that known in the art, to identify, tag, and highlight quality control features in an image. The artificial intelligence aspect of the system improves the feature identification accuracy, and tag processing time, by generating a feature identification function using specific training data sets. If desired, the feature identification function may be a convolutional neural network (CNN). The feature identification function preferably identifies quality control features from images such as: excessive glare in the image; poor image resolution; dirt on the vehicle surface in the image; trash in the image; flags in the image; signs in the image; people or animals in the image, paper floor mats in the vehicle, etc. The feature identification system may also identify other features, such as vehicle make, vehicle model, vehicle angles, vehicle features, vehicle year, vehicle trim, image perspective, banners, text, incorrect cropping, background segmentation, level of image detail, shadows, glare, reflections, unwanted information such as license plate numbers, and other unwanted elements such as people, animals, trees, or other vehicles, lack or focus, poor resolution, rain, fumes, snow, dust, smoke, mud, unwanted or obtrusive banners or overlays, etc.

The machine learning artificial intelligence system may also improve the accuracy of feature detection by generating a training data set with a high relevance. The machine learning artificial intelligence system may train itself using feedback received from users of the system. To overcome lack of uniformity from images received for identification, the training data sets used by the identification system may include images that are modified to account for variations from images taken with mobile devices. The identification system may also be automatically updated as compliance rules change or are added, new images become available, vehicle information changes, and/or new images become available from a web scraper used to collect new images from online or other bulk sources. As information in online resources changes, the identification system may recalculate the feature identification function to improve results.

A novel feature of the machine learning artificial intelligence component of the system examines the images 30 and tags the images 30 with a list of predetermined quality control features found in the images 30. The machine learning artificial intelligence component of the system then compares the tags 92 against a list of compliance rules, such as image quality control display criteria, to give each image a quality control score. The quality control score may be calculated in any desired manner for calculating a score based upon variable inputs. In one embodiment the system 12 calculates the quality control score first by defining the various quality control features to be included in the quality control score, such as the presence in the image 30 of: of trash, dirt, or flags in background; paper floor mats; poor resolution, glare; poor lighting, etc.

Each selected quality control feature preferably corresponds to a particular “undesired” condition in the image 30 it is desired for the system 12 to detect. The system 12 associates a “severity” score with each quality control feature, representing the amount of that quality control feature in the image 30. By way of example, the system 12 may calculate the amount of dirt shown on the vehicle 40 in an image 30. If the image 30 shows two percent of the vehicle 40 in the image 30 covered with dirt, the severity score may be “98” to represent the percentage of the vehicle 40 not covered by dirt. Similarly, if the image 30 shows 90 percent of the vehicle 40 in the image 30 covered with dirt, the severity score may be “10.” The system 12 inputs the severity score into an algorithm to calculate the overall quality control score for the image 30.

Each of the selected quality control features is also given a weight that also goes into the algorithm. The weight may be on any desired scale. In one embodiment, if the image 30 not showing dirt on the vehicle 40 is more important than the image 30 not showing flags in the background, the weight for the amount of dirt on the vehicle in the image may be “3,” whereas the weight for the image showing a flag in the background may be “1.” The relative weights may be selected by a user 26, dealership, or manufacturer or may be automatically selected by the system based on feedback from users 26 or based on other criteria. The scoring scale for the quality control score may be any desired scale. In one embodiment scoring scale may be 0-100. If the algorithm analyzes more quality control features, analyzes the quality control features on a larger continuum, and/or has a large disparity in weights between the quality control features, a larger scale may be used. Similarly, if the algorithm analyzes fewer quality control features, analyzes the quality control features on a smaller continuum, and/or has a small disparity in weights between the quality control features, a smaller scale may be used.

For a given image 30, the system 12 analyzes the image 30, inputting the selected quality control features, as well as their associated severity and weights, into the algorithm to generate overall quality control score of the image 30. If the quality control score for the image 30 is below a predetermined score, the machine learning artificial intelligence component of the system then automatically modifies, or removes, the images or places them in compliance with the rules, and displays the modified images on a webpage or in any other desired format. As the system examines images associated with the object, the machine learning component of the system may continuously update itself to better identify features in the images for future compliance processing.

The system may also be provided with data associated with various features in the image. The machine learning artificial intelligence component of the system scans the images to identify and locate the features in the images. As used in this context, machine learning artificial intelligence refers to computer-aided supervised learning that uses complex mathematical formalisms to make inference-based assumptions to improve the accuracy of the mapping of inputs to outputs using one or more general rules. The system automatically adds or modifies a feature in images that are not in conformance with the compliance rules. For example, if the tag on the image indicates that the image is of the rear of the vehicle when the compliance rules mandate a front view, placing the quality control score below the predetermined score, the system automatically rejects the image for modification or display and, if no suitable image can be located, sends an alert to the user that the desired image is missing. In another example, if the system locates an image of a front view of the vehicle, but the system has tagged the image as having additional vehicles in the background, if the compliance rules mandate another background, either the system or the user may modify the image. Depending on the particular compliance rules, the system may leave the background blank, may automatically insert a solid color background, or may insert a detailed background such as a dealership backdrop. The system automatically uses the background tag to segment the image to remove the background from the image and replace the background with a desired new background. As the system examines images associated with the object, which in this case is a vehicle, the machine learning component of the system may continuously update itself to better locate features in the images that the system is capable of modifying. Whereas the system may not initially have the capability of modifying a feature of the image, for instance adjusting a side perspective view to a three-quarters front perspective view, with additional iterations and training on more images the system may eventually use machine learning artificial intelligence to modify the perspective of the image to the point where the image comports with the compliance rules.

Throughout the disclosure, examples are described where a computing device and/or a computing system analyzes images associated with an object to automatically identify features in the images, tag the images based on the features, and use those tags to modify and display the images. For example, a vehicle dealer wishing to create a standardized webpage of vehicles for sale may walk around the inventory lot taking pictures and/or videos of various vehicles with a mobile device. The dealer then sends the images and/or videos to the system that may be a cloud application, an application on the dealer's mobile device, etc. The system then automatically analyzes the images or extracted images from the videos to automatically use machine learning artificial intelligence to tag the features within the images and use those tags to identify images for display on the webpage. The system may also automatically identify vehicle features within the images, and tag those images with tooltips, bounding boxes, color-coded overlays, and/or interactive hotspots providing additional information relating to quality control features, such as unwanted signage in the image background, or vehicle feature information such as alloy rims. The system may also use the tag to automatically remove the unwanted signage from the image or place a banner across the image indicating that the vehicle has alloy rims. Once the system has selected and modified all of the images in accordance with the compliance rules, the system may automatically send the images to the user for review or displays the images on a webpage, or other location, in accordance with predetermined display protocols provided the system. The system may use machine learning artificial intelligence to train itself on image placement and use that training to position the images on the website in a preferable arrangement.

### EXEMPLARY SYSTEMS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first image could be termed a second image, and, similarly, a second image could be termed a first image, without departing from the scope of the present invention. The first image and the second image are both images, but they are not the same image.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as application and other smart phone functions. Exemplary embodiments of portable multifunction devices include, without limitation, the iPhone®, and iPad® devices from Apple Inc. of Cupertino, Calif. Other portable electronic devices, such as laptops or tablet computers with touch-sensitive surfaces (e.g., touch screen displays and/or touch pads) may also be used. It should also be understood that, in some embodiments, the device is not a portable communications device, but is a desktop computer with a touch-sensitive surface (e.g., a touch screen display and/or a touch pad).

In the discussion that follows, an electronic device that includes a display and a touch-sensitive surface is described. It should be understood, however, that the electronic device may include one or more other physical user-interface devices, such as a physical keyboard, stylus, a mouse and/or a joystick.

The device typically supports a variety of applications, such as one or more of the following: a telephone application, an e-mail application, an instant messaging application, a digital image management application, a digital camera application, a digital video camera application, a web browsing application, a digital music player application, and/or a digital video player application.

The various applications that may be executed on the device may use at least one common physical user-interface device, such as the touch-sensitive surface. One or more functions of the touch-sensitive surface as well as corresponding information displayed on the device may be adjusted and/or varied from one application to the next and/or within a respective application. In this way, a common physical architecture (such as the touch-sensitive surface) of the device may support the variety of applications with user interfaces that are intuitive and transparent to the user.

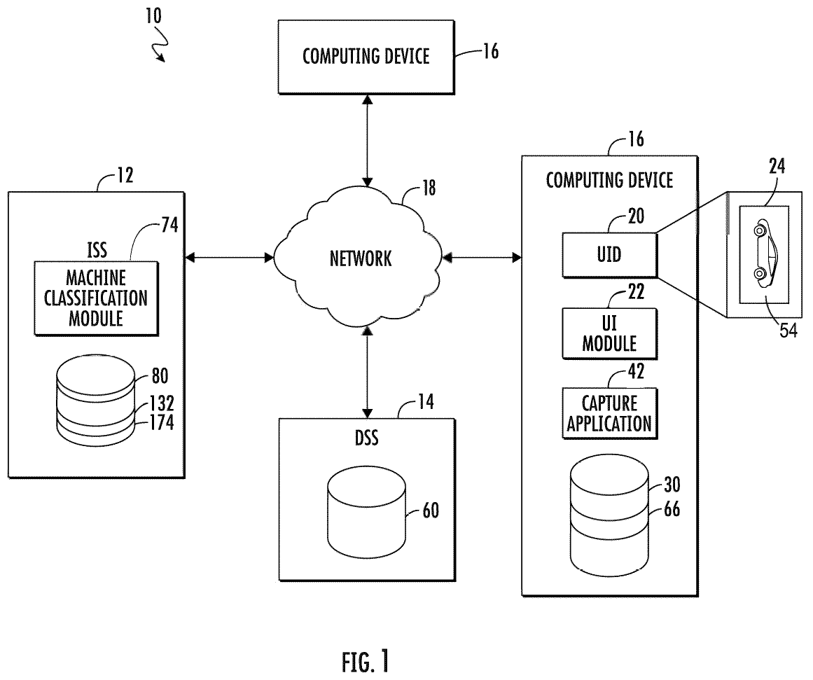

Attention is now directed toward embodiments of the system and method for automatically curating and displaying images. FIG. 1 is a conceptual diagram illustrating system 10 as an example system for automatically examining images, tagging features in the images, placing the images in compliance with a pre-determined ruleset, and publishing the resulting images, in accordance with one or more aspects of the present disclosure. System 10 includes at least one non-transitory computer-readable storage medium having computer-executable instructions stored thereon which, when executed by a computer, causes the computer to perform the method described below. The system 10 preferably has an information server system (“ISS”) 12 in communication, via network 18, with dealer server system (“DSS”) 14 and computing device 16. Although system 10 is shown as being distributed amongst ISS 12, DSS 14, and computing device 16, in other examples, the features and techniques attributed to system 10 may be performed internally, by local components of computing device 16.

Similarly, ISS 12 may include certain components and perform various techniques that are otherwise attributed in the below description to DSS 14 and computing device 16.

Network 18 represents any public or private communications network, for instance, cellular, Wi-Fi, and/or other types of networks, for transmitting data between computing systems, servers, and computing devices. ISS 12 may communicate, via network 18, with computing device 16 to receive images from the computing device 16. Similarly, ISS 12 may communicate, via network 18, with DSS 14 to receive data associated with objects (such as vehicles) depicted in images received from computing device 16.

Network 18 may include one or more network hubs, network switches, network routers, or any other network equipment, that are operatively inter-coupled thereby providing for the exchange of information between ISS 12, DSS 14, and computing device 16. Computing device 16, ISS 12, and DSS 14 may transmit and receive data across network 18 using any suitable communication techniques. ISS 12, DSS 14, and computing device 16 may each be operatively coupled to network 18 using respective network links. The links coupling computing device 16, ISS 12, and DSS 14 to network 18 may be Ethernet or other types of network connections and such connections may be wireless and/or wired connections.

Computing device 16 represents an individual mobile or non-mobile computing device. Examples of computing device 16 include a mobile phone, a tablet computer, a laptop computer, a desktop computer, a server, a mainframe, a set-top box, a television, a wearable device (e.g., a computerized watch, computerized eyewear, computerized gloves, etc.), a home automation device or system (e.g., an intelligent thermostat or home assistant), a personal digital assistants (PDA), portable gaming systems, media players, e-book readers, mobile television platforms, automobile navigation and entertainment systems, or any other types of mobile, non-mobile, wearable, and non-wearable computing devices configured to receive information via a network, such as network 18.

Computing device 16 includes user interface device (UID) 20 and user interface (UI) module 22. Module 22 may perform operations described using software, hardware, firmware, or a mixture of hardware, software, and firmware residing in and/or executing at respective computing device 16. Computing device 16 may execute module 22 with multiple processors or multiple devices. Computing device 16 may execute module 22 as virtual machines executing on underlying hardware. Module 22 may execute as one or more services of an operating system or computing platform. Module 22 may execute as one or more executable programs at an application layer of a computing platform.

UID 20 of computing device 16 may function as an input and/or output device for computing device 16. UID 20 may be implemented using various technologies. For instance, UID 20 may function as an input device using presence-sensitive input screens, such as resistive touchscreens, surface acoustic wave touchscreens, capacitive touchscreens, projective capacitance touchscreens, presence-sensitive screens, acoustic pulse recognition touchscreens, or another presence-sensitive display technology. In addition, UID 20 may include microphone technologies, infrared sensor technologies, or other input device technology for use in receiving user input.

UID 20 may function as output (e.g., display) device using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 16. In addition, UID 20 may include speaker technologies, haptic feedback technologies, or other output device technology for use in outputting information to a user.

UID 20 may include a presence-sensitive display that may receive tactile input from a user of computing device 16. UID 20 may receive indications of tactile input by detecting one or more gestures from a user (e.g., the user touching or pointing to one or more locations of UID 20 with a finger or a stylus pen). UID 20 may present output to a user, for instance at a presence-sensitive display. UID 20 may present the output as a graphical user interface (e.g., user interface 24), which may be associated with functionality provided by computing device 16 and/or a service being accessed by computing device 16.

For example, UID 20 may present a user interface (e.g., user interface 24) related to uploading images to ISS 12 which UI module 22 accesses from ISS 12 on behalf of computing device 16. In some examples, UID 20 may present a user interface related to image collection and distribution functions provided by UI module 22 or other features of computing platforms, operating systems, applications, and/or services executing at or accessible from computing device 16 (e.g., electronic message applications, Internet browser applications, mobile or desktop operating systems, etc.).

UI module 22 may manage user interactions with UID 20 and other components of computing device 16 including interacting with ISS 12 so as to provide image feature identification and image modification results at UID 20. UI module 22 may cause UID 20 to output a user interface, such as user interface 24 (or other example user interfaces) for display, as a user of computing device 16 views output and/or provides input at UID 20. UI module 22 and UID 20 may interpret inputs detected at UID 20 and may relay information about the inputs detected at UID 20 to one or more associated platforms, operating systems, applications, and/or services executing at computing device 16, for example, to cause computing device 16 to perform functions.

UI module 22 may receive information and instructions from one or more associated platforms, operating systems, applications, and/or services executing at computing device 16 and/or one or more remote computing systems, such as ISS 12 and DSS 14. In addition, UI module 22 may act as an intermediary between the one or more associated platforms, operating systems, applications, and/or services executing at computing device 16, and various output devices of computing device 16 (e.g., speakers, LED indicators, audio or electrostatic haptic output device, etc.) to produce output (e.g., a graphic, a flash of light, a sound, a haptic response, etc.) with computing device 16.

In the example of FIG. 1, user interface 24 is a graphical user interface associated with a customer assistance service provided by ISS 12 and accessed by computing device 16. As shown in FIG. 1, user interface 24 presents “image capture” from ISS 12 to aid a user in capturing images to curate and display in accordance with predetermined rules. User interface 24 may present product information in various forms such as text, graphics, content cards, images, etc. UI module 22 may cause UID 20 to output user interface 24 based on data UI module 22 receives via network 18 from ISS 12. UI module 22 may receive graphical information (e.g., text data, images data, etc.) for presenting user interface 24 as input from ISS 12 along with instructions from ISS 12 for presenting the graphical information within user interface 24 at UID 20.

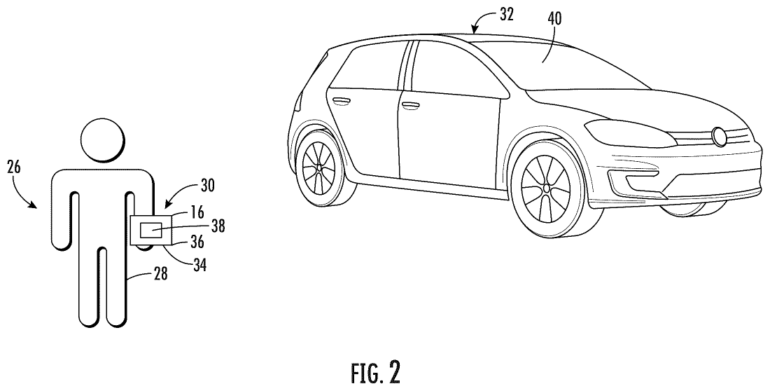

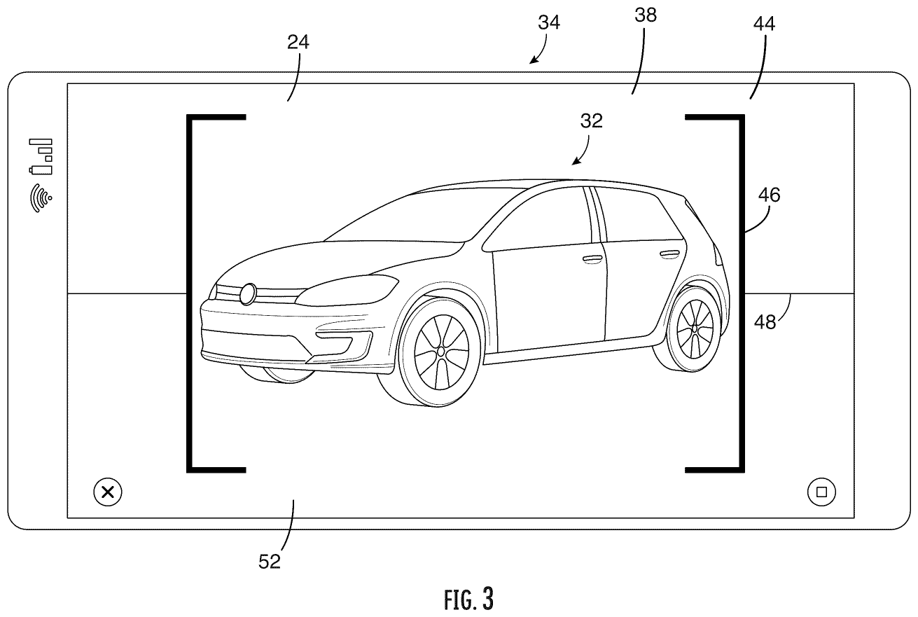

FIG. 2 is a perspective view of a user 26, in this embodiment a vehicle dealer 28, using computing device 16 to capture images 30 by taking multiple pictures of an item, such as an object 32. In this embodiment, computing device 16 is a mobile phone 34 having a camera 36 and display 38, and the object 32 is a vehicle 40. When dealer 28 wishes to use system 10 to display images in accordance with predetermined compliance rules, dealer 28 launches a downloaded application 42 running locally on computing device 16. FIGS. 1-3. As shown in FIG. 3, when dealer 28 launches application 42, display 38 of computing device 16 displays an image capture screen 44. As shown in FIG. 3, when dealer 28 focuses computing device 16 to capture an image 30, system 10 presents, on display 38 associated with computing device 16, the user interface 24.

User interface 24 provides multiple aids to assist dealer 28 in optimizing image capture to facilitate system 10 displaying images in compliance with a set of pre-determined rules. User interface 24 preferably automatically indicates to the dealer 28 the images and perspectives desired for display. Two such aids are target brackets 46 and level lines 48 that indicate to dealer 22 where to position vehicle 40 on display 38 to facilitate system 16 being able to analyze, tag, modify, display, and curate a first image 52. When dealer 22 aims computing device 16 at vehicle 40, user interface 24 associated with system 10 displays target brackets 46 and level lines 48. Dealer 28 adjusts camera 36 of computing device 16 until object 32 appears on display 38 between the target brackets 46. Dealer 28 then adjusts camera 36 until level lines 48 are generally collinear with a centerline defined by vehicle 40 and captures the first image 52 of vehicle 40 showing the vehicle 40 from the first desired perspective. FIGS. 1, 3, and 5A-C. To capture a second image 54, dealer 28 moves to a second location automatically indicated by the user interface 24 to capture the second image 54 from the desired location, points camera 36 toward vehicle 40, and captures a second image 54 in a manner such as that described above. Dealer 28 repeats this process, capturing as many images, from as many angles, as automatically indicated by the user interface 24.

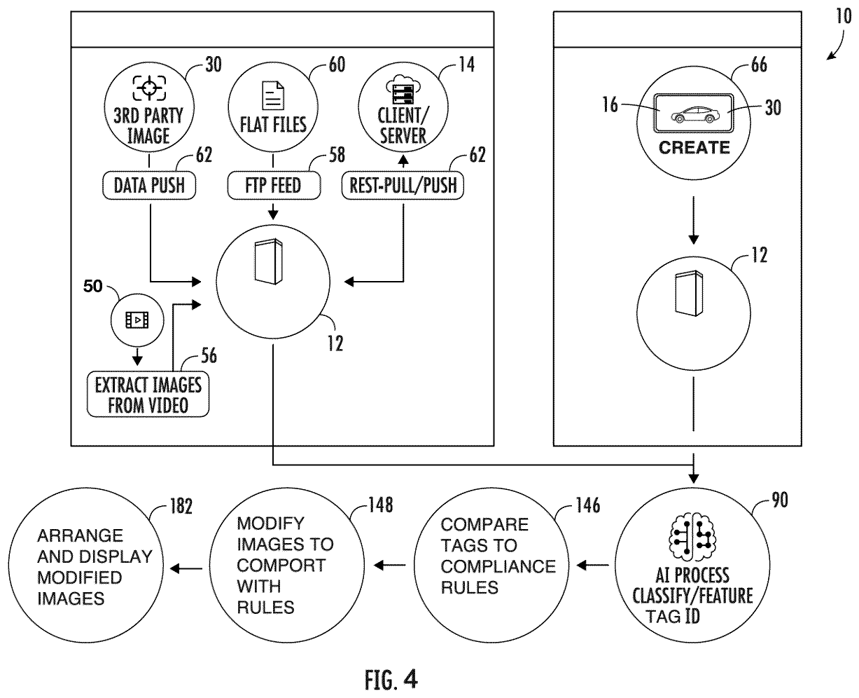

As shown in FIG. 4, once images 30 of object 32 have been captured, system 10 automatically transfers data from computing device 16 to be received by ISS 12. This data comprises at least one image from the plurality of images 30. Preferably system 10 automatically transfers supplemental data from computing device 16 to ISS 12 containing all of the remaining desired images 30. Alternatively, as shown in FIG. 4, dealer 28 may manually upload images 30 from computing device 16 to ISS 12. As another alternative, dealer 28 may upload images 30 from computing device 16 to DSS 14, which, in turn, uploads images 30 to ISS 12.

Instead of captured still images, images 30 may instead be still images automatically extracted 56 by system 10 from standard video files 50. ISS 12 may also receive data relating to images 30 via FTP feed 58 from a flat files database 60 or from DSS 14, using representational state transfer (REST) pull/push 62 or similar architecture. This additional data may relate to vehicle 40 shown in images 30, such as make, model, year, damage, or special features. As shown, the user 26 can create 66 an image 30 using a camera 36 as described above or using digital tools, either alone or in conjunction with the camera, such as artificial intelligence art tools, such as those known in the art, and upload the resulting image 30 to ISS 12.

As described more fully below, from the ISS 12, system 10 uses a machine feature identification module 74 employing machine learning artificial intelligence to automatically identify features 76 in images 30, and automatically tag 90 those images 30 with information associated with the features. System 10 also uses machine learning artificial intelligence to automatically determine 146 if the image 30 is tagged with a feature 76 associated with a predetermined compliance rule 134. If the image 30 is tagged with a feature 76 associated with a predetermined compliance rule 134, system 10 uses machine learning artificial intelligence to generate 148 a modified image 170 in accordance with the particular compliance rule 134 and arrange and display 182 the modified image 170 in accordance with a predetermined display rule.

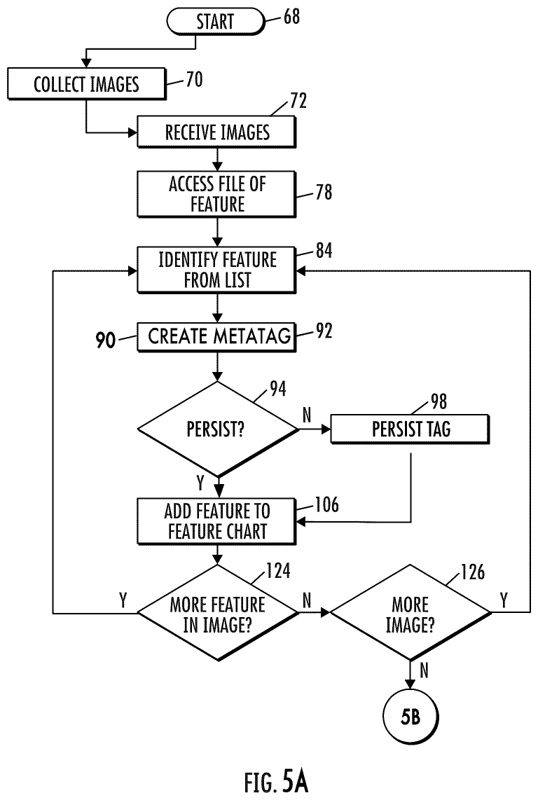

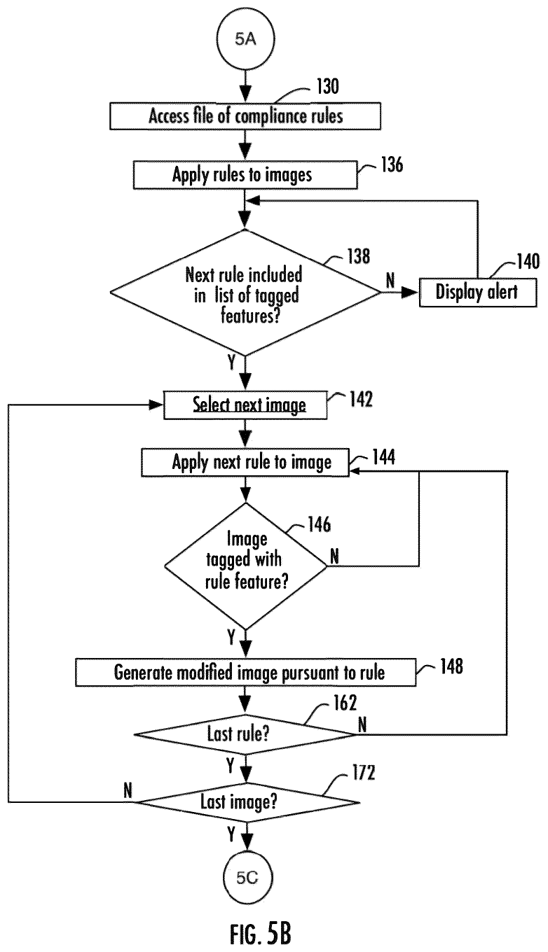

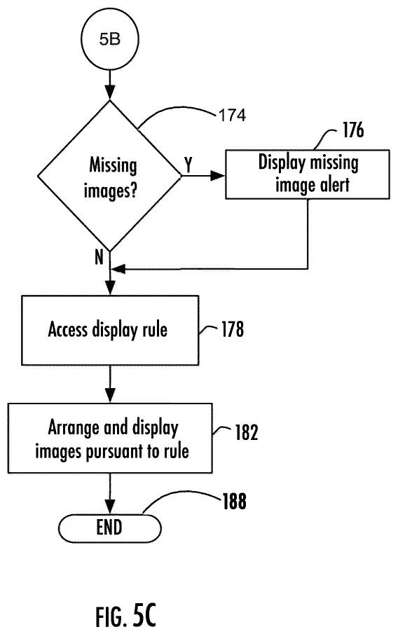

As shown in FIG. 5, the process for examining, tagging, selecting, modifying, and posting images using system 10 is preferably completely automated, starting 68 with dealer 28 collecting 70 images 30, and ISS 12 receiving 72 those images 30. Upon receipt of images 30, system 10 uses machine feature identification module 74 to identify features 76 in images 30. Machine feature identification module 74 accesses 78 ISS 12 to retrieve a file 80 containing a predetermined list 82 of features 76 of vehicles 40 to be identified in images 30. In addition to list 82, ISS 12 may store numerous files 80 containing different predetermined lists 82 of features 76 to be identified in images 30 of various vehicles 40 and other objects 32 as desired.

Machine feature identification module 74 uses machine learning artificial intelligence and contextual image classification to identify patterns in first image 52 based on contextual information in image 52, such as the groupings of pixels surrounding a target pixel. Machine feature identification module 74 automatically compares contextual information derived from first image 52 against features 76 in list 82 to identify 84 targets 86 and create 90 metadata tags 92 that the system 14 associates with the first image 52.

For example, as shown in FIGS. 1, 5A-C, 6, and 7, machine feature identification module 74 receives 72 images 30 from dealer 28, accesses 78 a list 82 of features 76 from ISS 12, identifies 84 a target 86 in first image 52 as a feature 76 of vehicle 40 on list 82, such as a the image being the side view 88 of the vehicle 40, and adds creates 90 a metadata tag 92 indicating that the first image 52 shows a vehicle 40 in side view 40, and associates that side view metadata tag 92 with the first image 52. Once a feature 76 has been identified in the first image 52, machine feature identification module 74 determines 94 whether a persist has been performed on metadata tag 92, namely whether the system 10 has taken metadata tag 92 existence and added it to the context of first image 52, so that metadata tag 92 is managed viz. (future updates to metadata tag 92 will continue to be tracked). If a persist has not been performed on metadata tag 92, system 10 persists 98 metadata tag 92, storing the feature information in a database for later retrieval.

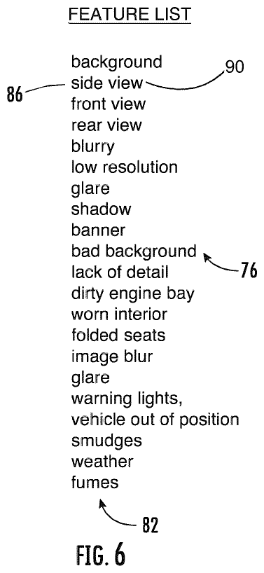

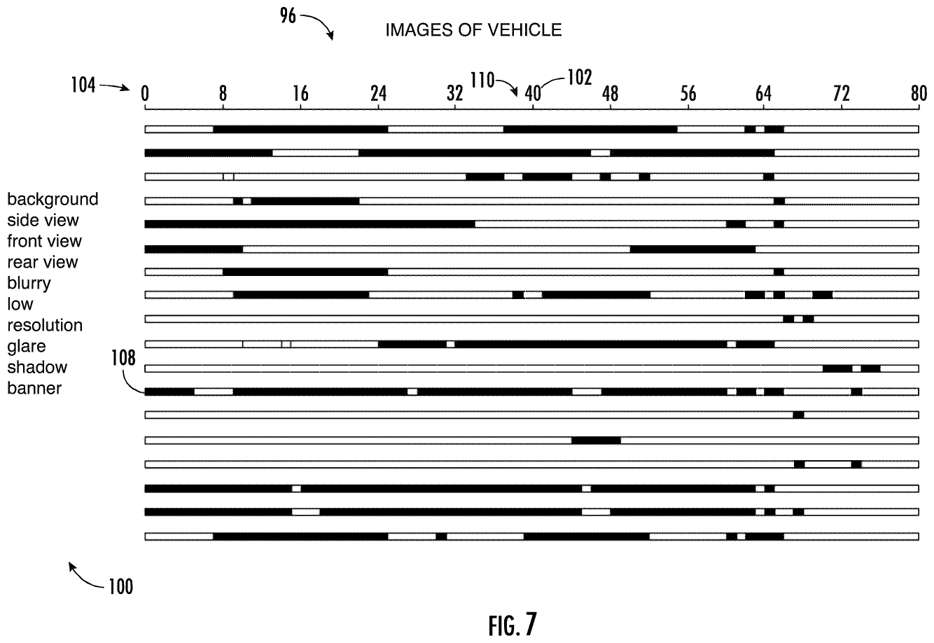

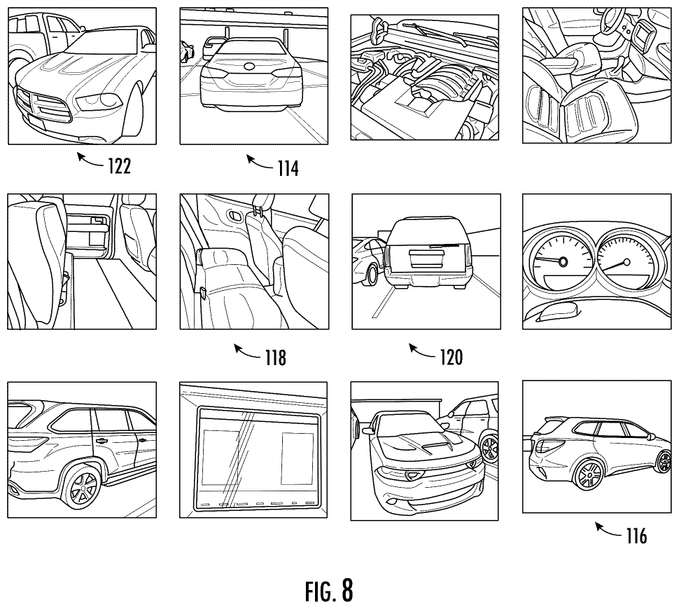

As shown in FIG. 7, if desired, system 10 can generate and display a feature chart 96 listing features 76 machine feature identification module 74 finds in images 30, listing features 76 along a y-axis 100 and image numbers 102 along an x-axis 104. While a unique number 110 is preferably a number identifying the sequential order in which the associated image 30 was captured, the unique number 110 may instead be randomly selected or otherwise assigned as desired. For example, as shown in FIGS. 6-8, if first image 52 is associated with a unique number (40) 110, machine feature identification module 74 automatically identifies 84 features in the image 52 including background 114, side view 116, blurry 118, glare 120, and shadow 122 and darkens all portions of lines 108 in feature chart 96 corresponding to those features 76 under image number (40). FIG. 6 shows and example of a partial the list of features 76 in the preferred embodiment includes whether the image 30 includes a bad background, lack of detail, dirty engine bay, worn interior, folded seats, image blur, glare, warning lights, vehicle out of position, smudges, weather, fumes, etc. However, the features 76 may include anything in images 30 and/or any information associated with images 30.

After system 10 determines the metadata tag 92 has had a persist performed on it, machine feature identification module 74 determines 124 if there are any more unidentified features 76 in first image 52 and, if so, returns to step 84. System 10 continues until machine feature identification module 74 determines 124 there are no more unidentified features 76 in first image 52, at which point, module 74 determines 126 if there are any more images 30 that have not been analyzed and added to feature chart 96. For example, if machine feature identification module 74 determines 124 there are no more unidentified features 76 in first image 52, module 74 returns to step 84 and analyzes second image 54. System 10 continues in this manner until machine feature identification module 74 has identified and added all desired features 76 in all images 30 to feature chart 96, at which point the module 74 curates the images, using metadata tags 92 to access 130 a list of compliance rules 134, such as partial list 132, and apply 136 them to images 30.

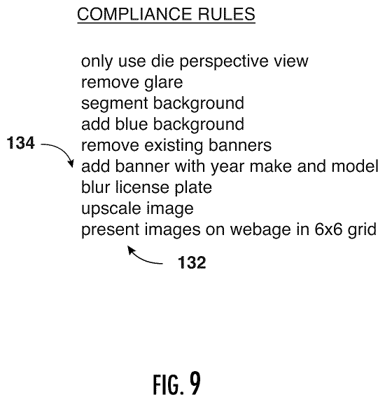

To apply 136 compliance rules 134 to images 30, system 10 accesses 130 a list 132 of compliance rules 134 from ISS 12 or any desired type of digital storage known in the art. FIGS. 1, 5A-C, and 9. List 132 of compliance rules 134 may be created by dealer 28 or a third-party. As shown in FIG. 9, list 132 includes those particular compliance rules 134, selected from list 82 of features 76 tagged by system 10, that dealer 28 desires system 10 to apply to images 30. In addition to list 132, ISS 12 may store numerous files containing different predetermined lists 132 of compliance rules 134 to apply to images 30 of various vehicles 40 as desired. List 132 may include compliance rules 134 not included in list 82 of features 76 tagged by system 10, in which case system 10 will determine 138 that feature 76 is not tagged and will display 140 a visual alert to dealer 28 that that particular compliance rule 134 could not be applied to images 30 as compliance rule 134 is not included within list 82 of features 76 tagged by system 10.

If system 10 determines 138 that feature 76 is tagged by system 10, system 10 selects 142 next image 30 for processing and automatically applies 144 that compliance rule 134 to image 30. If system 10 determines 146 that image 30 is not tagged with a feature 76 associated with a compliance rule 134, system 10 returns to step 144 to apply the next compliance rule 134 on list 132 to image 30. If, however, system 10 determines 146 that image 30 is tagged with a feature 76 associated with a compliance rule 134, system 10 automatically uses the tag associated with the feature to execute the rule to execute a predetermined action relating to the image, such as replacing the background on the image, and displaying at least an element of the image on a visually perceptible display, such as displaying the modified image on a webpage of a website displayed on a display, such as display 38. To accomplish this, system 10 automatically uses the tag associated with the feature to generate 148 a modified image in accordance with the particular compliance rule 134. Alternatively, system 10 may automatically use the tag associated with the feature to execute a rule selecting or eliminating a particular image based on the feature tagged in the image.

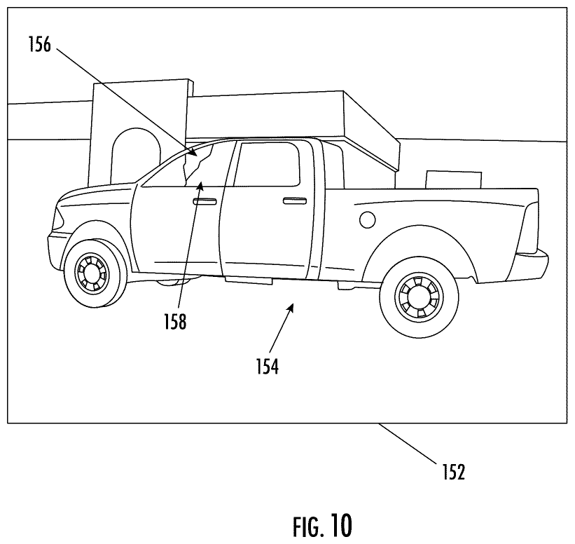

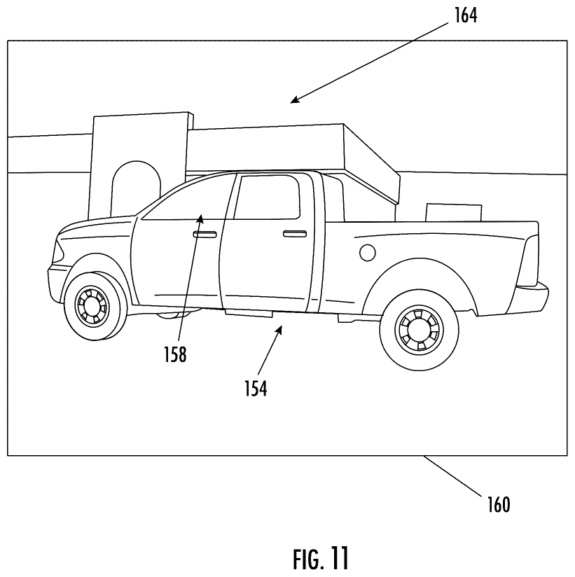

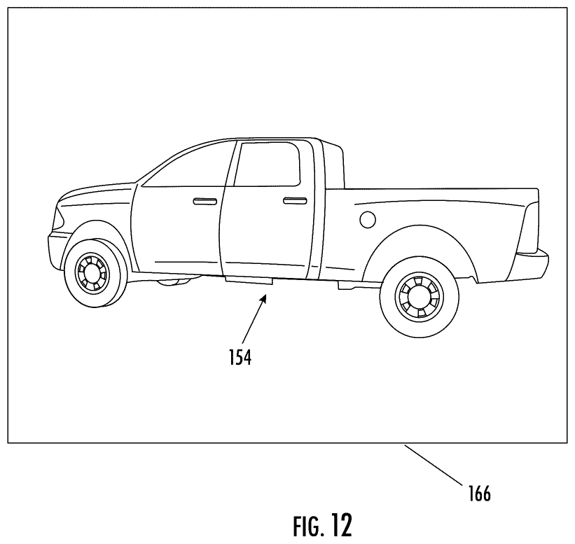

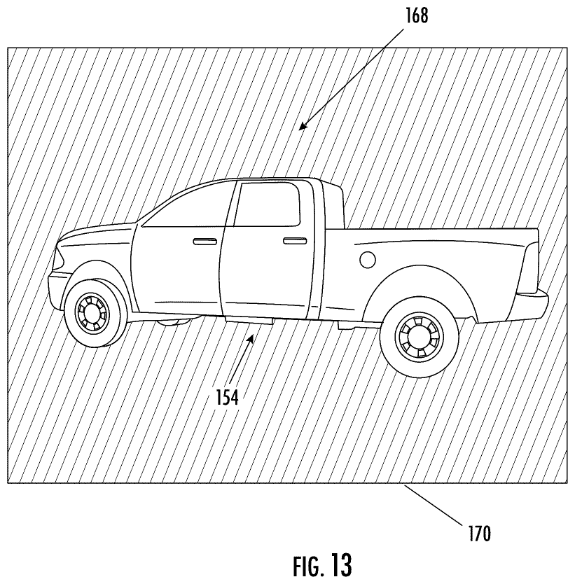

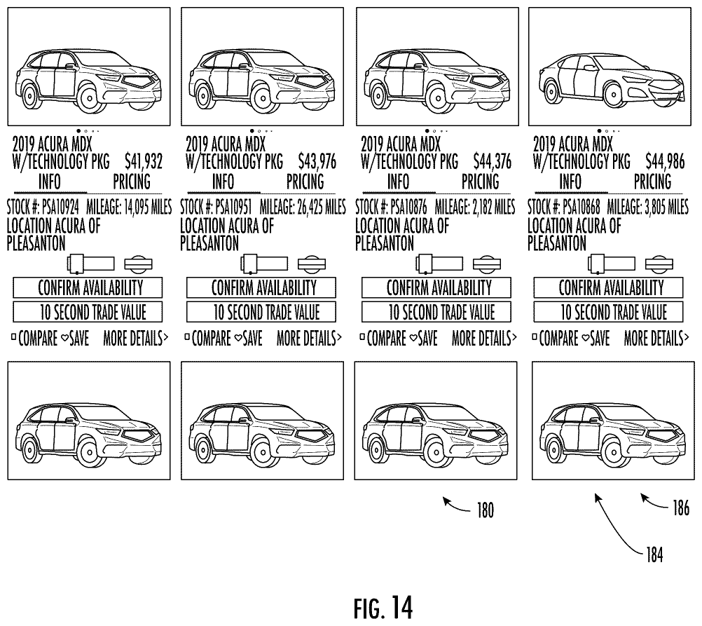

In an exemplary embodiment, system 10 selects image 152 of a vehicle 154 with glare 156 on window 158. FIGS. 1, 5A-C, and 10-13. In a manner noted above, system 10 will have previously tagged image 152 with a “glare” tag, indicating where in image 152 glare 156 is located. FIGS. 10-12. System 10 determines 138 that feature 76 “glare” has already been tagged in image 152 and uses that tag to identify the location of glare 156 in image 152 and automatically applies 144 compliance rule 134 “remove glare” to image 152. System 10 removes glare 156 by implementing machine learning artificial intelligence, such as that known in the art, to manipulate image 152 to produce a modified image 160 of vehicle 154 with glare 156 on window 158 removed.

Once system 10 has generated modified image 160, system 10 determines 162 if the previously implemented compliance rule 134 was the last compliance rule 134. If system 10 determines 162 that the previously implemented compliance rule 134 was not the last compliance rule 134, system 10 applies 144 the next compliance rule 134 to modified image 160. The process continues in this manner until system 10 determines 162 the previously implemented compliance rule 134 was the last compliance rule 134.

In the above-identified exemplary embodiment, system 10 determines 162 that the “remove glare” compliance rule 134 was not the last compliance rule 134 and applies the next compliance rule 134 to modified image 160. As modified image 160 retains the previous tags associated with the features in original image 152, system 10 determines that the feature “background” has already been tagged in image 160 and uses that tag to identify the location of background 164 in image 160 and automatically applies 144 compliance rule 134 “segment background” to image 160. System 10 separates background 164 in image 160 from vehicle 154 in image 160 by using contextual image classification and machine learning to identify patterns in image 160 based on contextual information in image 160, such as the groupings of pixels surrounding a target pixel to differentiate vehicle 154 within image 160 from background 164. Once vehicle 154 and background 164 have been separated from one another, system 10 segments image 160 by identifying all background 164 in image 160 that is not vehicle 154, and removes background 164 from image 160, creating another image 166 displaying only vehicle 154. System 10 can also use segmentation to identify any blemishes or damage on vehicle 154, to which system 10 can automatically identify with tags and/or hotspots allowing anyone viewing image 160 to click on the hotspot and receive information about the blemish or damage. System 10 determines 162 that the “segment background” compliance rule 134 was not the last compliance rule 134 and, having determined that the feature “background” has already been tagged in image 164, again uses that tag to identify the location of background 164 in image 166 and automatically applies 144 compliance rule 134 “add blue background” to image 166. Just as system 10 segmented background 164 from image 160 above, system 10 adds a blue background 168 to image 166, creating another new image 170, and adding a tag to image 170 that image 170 has had background 164 removed and a blue background 168 added.

System 10 continues in this manner applying all of compliance rules 134 to image 170 until system 10 determines 162 the previously implemented compliance rule 134 was the last compliance rule 134. System 10 then determines 172 if current image 30 being modified is the last image 30 to be modified. If the current image 30 being modified is not the last image 30 to be modified system 10 selects 142 the next image 30 and repeats the foregoing process. If the current image 30 being modified is the last image 30 to be modified system 10 determines 174 if there are any missing images. For instance, if one of compliance rules 134 states that only images of “side perspective views” of vehicles 40 are to be used, and system 10 is unable to identify or generates a side perspective view from the images of a particular vehicle 40, system 10 displays 176 a visually identifiable alert. This alert may be of any manner known in the art.

If there are no missing images, system 10 accesses 178 display rules from ISS 12 or any desired type of digital storage known in the art. The display rules may be created by dealer 28 or a third-party. The display rules include instructions on how dealer 28 desires system 10 to display modified images 180. In addition to the display rules, ISS 12 may store numerous files containing different display rules to apply at different times, to different sets of images as desired. For example, a vehicle manufacturer may wish for all of their vehicles sold by dealer 28 to comport with particular compliance rules 134 and to be displayed in a certain manner that may be different from the preferred compliance rules and display parameters of another vehicle manufacturer or dealer 28. System 10 may even be designed to implement particular compliance rules and display parameters depending on particular customer requests or dynamic input received through dealer's website 184.

Once system 10 accesses 178 the display rules, system 10, arranges and displays 182 modified images 180 in accordance with those display rules. As shown in FIG. 17, the display rules may dictate that the modified images are to be automatically uploaded to dealer's website 184 in a 4×2 grid 186. Once system 10 displays modified images 180 in accordance with the display rules, the process is completed 188. System 10 may be implemented to provide audit reports listing the features identified in the images, modifications made to the images, missing images, as well as the manner in which modified images 180 were arranged, sequenced, and displayed. By using system 10 of the present invention, dealer 28 can ensure that all of the modified images 180 are in compliance with the rules and arranged in the predetermined arrangement. Alternatively, system 10 can use machine learning artificial intelligence, training on vehicles that have sold through website 184, to modify the compliance rules and display and arrangement parameters to generate and display images in manner designed to increase sales of vehicles shown in the images.

In an alternative embodiment, the compliance rules 134 may be quality control display criteria, such as rules relating to: excessive glare in the image; poor image resolution; dirt on the vehicle surface in the image; trash in the image; flags in the image; signs in the image; people or animals in the image, paper floor mats in the vehicle, etc. Different sets of compliance rules may be used for different vehicle manufacturers, different dealers, different markets, etc. The system 12 applies the quality control display criteria to an image 30 to generate a quality control score based on the extent to which the images 30 do, or do not, comply with the quality control display criteria.

When the system 12 receives 72 the images 30 from the user 26, the system 12 automatically uses the machine learning model 74 to compare the images 30 against the quality control display criteria to give each image 30 a quality control score. The quality control score may be weighted as desired, giving greater or lesser weight to the degree to which various quality control features of the image 30 comply with the quality control display criteria. If the quality control score falls below a predetermined score, the system 12 may automatically notify the user 26 of the changes in the image needed to increase the quality control score and/or automatically edit the image 30 to produce another image with a quality control score above the predetermined score.

The editing may involve: removal of glare in the image; enhancing the image resolution; removing dirt on the vehicle surface in the image; removing trash, flags, signs, people, animals, paper floor mats etc. from the image in a manner such as those known in the art. If the quality control score is above the predetermined score, either initially or after modification by the system 12, the system 12 may automatically perform an action on the image, such as publishing the image 30 to the website 184. If the quality control score falls below the predetermined score, the system may perform additional actions such as sending an alert to the user 26 of the low-quality control score and instructing the user 26 to capture a new image 30 after cleaning the vehicle 40, repositioning the vehicle 40, removing items from the background, recapturing the image from a different angle, etc.

The system 12 automatically highlights in the image 30, with a visually perceptible indicators, those quality control features that are not in compliance with the quality control display criteria associated with that image 30. As described above, the system 12 may create 90 a metatag 92 associating the image 30 with the quality control score and the identified quality control features with which the image 30 is in, or out of, compliance. The system 12 may use those tags 92 to highlight the image 30 to point out the quality control features in the image 30 that are out of compliance with the quality control display criteria.

The visually perceptible indicator may be tooltips, bounding boxes around the quality feature, color-coded overlays, and/or interactive hotspots providing additional information relating to quality control features, such as unwanted signage in the background of the image 30. As noted above, the system 12 may also automatically modify the image 30 by segmenting the image 30, adding an overlay to the image 30, and/or removing items from the image 30, in response to the quality control score falling below a predetermined score. The system 12 may use various colors in the color-coded overlays to indicate the degree to which the quality control feature is out of compliance with the quality control display criteria.

The system 12 may send the highlighted image directly to the user 26, displaying the highlighted image 30 and quality control score on the display 38 for the user 26 to see. The system 12 may prompt the user 26 to: correct the image sufficiently to increase the quality control score above to the predetermined score; send feedback input to the system 12 associated with the image 30; generate a new image addressing the highlighted quality control features; override the quality control display criteria; store the image 30 without publishing it; and/or delete the image. The system 12 may also prompt the user 26 to send feedback input back to the system 12. The feedback may be actions such as returning to the system 12 a quality control score modified by the user 26 or returning to the system 12 a modified rule associated with the quality control display criteria. The user 26 may indicate whether the modified rule applies to all images, a group of images, or to just a single image 30. The feedback input from the user 26 may be comments regarding the compliance score, various quality control display criteria, and/or instructions to override the quality control score and publish the image 30 on the website 184.

The system 12 associates the feedback input with the image 30 and aggregates the input with input associated with other images and other users to create an aggregate library of input stored on the database 60. The system 12 may use the tags, feedback input, and/or the aggregate library to modify the quality control display criteria and/or train its machine learning machine feature identification module 74 in a manner known in the art of machine learning to adjust the manner in which the system 12 assesses the quality control display criteria and determines the quality control score. The system 12 may use the feedback input to automatically modify the image as described above or prompt the user 26 to capture a new supplemental image of the vehicle 40 in a manner that produces a new quality control score associated with the supplemental image that is higher than the predetermined quality control score. Similarly, the system 12 may use the metatag 92 and/or the feedback input to automatically perform an action on the image 30, such as publishing the image 30 to the website 184 or modifying the image as described above, and/or may prompt the user 26 to capture a new supplemental image of the vehicle 40 in a manner that produces a new quality control score associated with the supplemental image that is higher than the predetermined quality control score.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. For example, the system described herein is not limited to vehicles, but may be used with any images of any subjects that a user 26 wishes to automatically modify and display.

1. At least one non-transitory computer-readable storage medium having computer-executable instructions stored thereon which, when executed by a computer, causes the computer to perform a method comprising:
providing a predetermined set of rules associated with image quality-control display criteria;
receiving an image of a vehicle;
identifying a quality control feature in the image;
automatically using machine learning to compare the quality control feature against the set of predetermined rules to produce a quality control score;
automatically highlighting the quality control feature in the image with a visually perceptible indicator;
displaying to a user the image with a visually perceptible indicator;
displaying to the user the quality control score;
receiving input from the user associated with the quality control feature; and
associating the input with the image in a database.

2. The at least one non-transitory computer-readable storage medium of claim 1, wherein the method performed by the computer further comprises using the input to capture a supplemental image of the vehicle in a manner that produces a supplemental quality control score that is higher than the quality control score.

3. The at least one non-transitory computer-readable storage medium of claim 1, wherein the machine learning is a machine learning model selected from the group consisting of image classification, object detection, and image segmentation.

4. The at least one non-transitory computer-readable storage medium of claim 1, wherein the predetermined set of rules comprises rules selected from the group consisting of glare in the image, poor image resolution, dirt on the vehicle surface in the image, trash in the image, flags in the image, signs in the image, and paper floor mats in the vehicle in the image.

5. The at least one non-transitory computer-readable storage medium of claim 1, wherein automatically highlighting the quality control feature in the image with a visually perceptible indicator comprises generating bounding boxes in the image around the quality control feature.

6. The at least one non-transitory computer-readable storage medium of claim 1, wherein automatically highlighting the quality control feature in the image with a visually perceptible indicator comprises generating color-coded overlays in the image associated with the quality control feature.

7. The at least one non-transitory computer-readable storage medium of claim 1, wherein the method performed by the computer further comprises automatically associating the image with a tag, wherein the tag is a variable associated with the quality control score.

8. The at least one non-transitory computer-readable storage medium of claim 7, wherein the method performed by the computer further comprises using the tag to automatically perform an action on the image.

9. The at least one non-transitory computer-readable storage medium of claim 8, wherein the action is publishing the image to a website.

10. The at least one non-transitory computer-readable storage medium of claim 1, wherein the method performed by the computer further comprises using the quality control score to automatically perform an action on the image.

11. The at least one non-transitory computer-readable storage medium of claim 10, wherein the action is notifying the user of changes to the image needed to increase the quality control score.

12. The at least one non-transitory computer-readable storage medium of claim 10, wherein the action is an action selected from the group consisting of cleaning the vehicle, repositioning the vehicle, removing items from the background, and recapturing the image from a different angle.

13. The at least one non-transitory computer-readable storage medium of claim 10, wherein the method performed by the computer further comprises detecting glare in the image and wherein the action is an action selected from the group consisting of cleaning the vehicle, repositioning the vehicle, removing items from the background, and recapturing the image from a different angle.

14. The at least one non-transitory computer-readable storage medium of claim 1, wherein the method performed by the computer further comprises automatically modifying the image with a process selected from the group consisting of segmenting the image, adding an overlay to the image, removing items from the image, and adding hotspots to the image, in response to the quality control score exceeding a predetermined score.

15. The at least one non-transitory computer-readable storage medium of claim 1, wherein automatically highlighting the quality control feature in the image with a visually perceptible indicator comprises adding a tooltip to the image associated with the quality control feature.

16. The at least one non-transitory computer-readable storage medium of claim 1, wherein receiving input from the user comprises receiving a modified quality control score from the user.

17. The at least one non-transitory computer-readable storage medium of claim 1, wherein receiving input from the user comprises receiving from the user a change to a rule associated with the predetermined set of rules as the rule applies to the image.

18. The at least one non-transitory computer-readable storage medium of claim 1, wherein the method performed by the computer further comprises sending an alert to the user in response to the quality control score falling below a predetermined score.

19. The at least one non-transitory computer-readable storage medium of claim 1, wherein the method performed by the computer further comprises:
aggregating the input from the user with inputs from other users to produce an aggregate library;
training the machine learning on the aggregate library; and
using the aggregate library to modify the predetermined set of rules.

20. A method for curating images comprising:
providing a predetermined set of rules associated with image quality-control display criteria;
receiving an image of a vehicle;
identifying a quality control feature in the image;
automatically using machine learning to compare the quality control feature against the set of predetermined rules to produce a quality control score;
automatically highlighting the quality control feature in the image with a visually perceptible indicator;
displaying to a user the image with a visually perceptible indicator;
displaying to the user the quality control score;
receiving input from the user associated with the quality control feature; and
associating the input with the image in a database.
